(19) United States
(12) Patent Application Publication
(10) Pub. No.: US 2022/0036619 A1
(43) Pub. Date: Feb. 3, 2022

(54) ANIMATION PRODUCTION SYSTEM

(71) Applicant: AniCast RM Inc., Minato-ku (JP)

(72) Inventors: Yoshihito KONDOH, Chuo-ku (JP); Masato MUROHASHI, Tokyo (JP)

(21) Appl. No.: 17/007,976

(22) Filed: Aug. 31, 2020

(30) Foreign Application Priority Data
Jul. 29, 2020 (JP) 2020-128295

(51) Int. Cl. G06T 13/40; G06Q 20/12

(52) U.S. Cl. CPC G06T 13/40; G06T 2200/24; G06Q 20/123

(57) ABSTRACT

To reduce the burden of animation production, an animation production system comprises a virtual camera that shoots a character placed in a virtual space; an asset store provided in the virtual space in which an asset available for the shooting is disposed in the virtual space; and a virtual hand of a user in the virtual space, wherein the asset selected from the asset store can be operated by the virtual hand.

### TECHNICAL FIELD

The present invention relates to an animation production system.

### BACKGROUND ART

Virtual cameras are arranged in a virtual space (see Patent Document 1).

### CITATION LIST

### Patent Literature

[PTL 1] Patent Application Publication No. 2017-146651

### SUMMARY OF INVENTION

### Technical Problem

In creating animations, assets (e. g. , character model data, audio data, music data, illustration data, etc.) are required, but it is very burdensome for the producer to create all the assets independently. On the other hand, if the creator searches out the necessary assets from time to time outside the virtual space on the Internet and downloads them for a fee or free and incorporates them into the animation being produced, the efficiency of animation production and the sense of immersion will be reduced. In addition, after the asset is downloaded, it is found to be different from the image in the virtual space, and it must be downloaded again, or animation must be corrected, which in turn reduces the efficiency and immersion of animation production.

The present invention has been made in view of this background, and is intended to provide a technology that can reduce the burden of animation production.

### Solution to Problem

The principal invention for solving the above-described problem is an animation production system comprising: a virtual camera that shoots a character placed in a virtual space; an asset store provided in the virtual space in which an asset available for the shooting is disposed in the virtual space; and a virtual hand of a user in the virtual space, wherein the asset selected from the asset store can be operated by the virtual hand.

The other problems disclosed in the present application and the method for solving them are clarified in the sections and drawings of the embodiments of the invention.

### Advantageous Effects of Invention

According to the present invention, the burden of animation production can be reduced.

### BRIEF DESCRIPTION OF DRAWINGS

FIG. 1 is a diagram illustrating an example of a virtual space displayed on an HMD mounted by a user in an animation production system of the present embodiment;

FIG. 2 is a diagram illustrating an example of the overall configuration of an animation production system 300 according to an embodiment of the present invention.

FIG. 3 is a schematic view illustrating an appearance of an HMD 110 according to the present embodiment;

FIG. 4 is a diagram illustrating an example of a functional configuration of the HMD 110 according to the present embodiment;

FIG. 5 shows a schematic view of the appearance of the controller 210 according to the present embodiment.

FIG. 6 is a diagram illustrating an example of a functional configuration of a controller 210 according to the present embodiment;

FIG. 7 is a diagram illustrating an example of a functional configuration of an image producing device 310 according to the present embodiment;

FIG. 8 is a diagram illustrating a purchase of an asset from an asset list 6 in an animation production system 300 according to the present embodiment;

FIG. 9 is a diagram illustrating a purchase of an asset from an asset list 6 in an animation production system 300 according to the present embodiment;

FIG. 10 is a diagram illustrating a purchase of an asset from an asset list 6 in an animation production system 300 according to the present embodiment;

FIG. 11 is a diagram illustrating a purchase of an asset from an asset list 6 in an animation production system 300 according to the present embodiment;

### DESCRIPTION OF EMBODIMENTS

The contents of embodiments of the present invention will be described with reference. The present invention includes, for example, the following configurations.

### Item 1

An animation production system comprising:

na virtual camera that shoots a character placed in a virtual space;

an asset store provided in the virtual space in which an asset available for the shooting is disposed in the virtual space; and

a virtual hand of a user in the virtual space,

wherein the asset selected from the asset store can be operated by the virtual hand.

### Item 2

The animation production system according to claim 1, wherein

the selected asset will be used at cost.

### Item 3

The animation production system according to claim 2, wherein

the selected asset can be operated prior to payment of the cost.

### Item 4

The animation production system according to claim 1, wherein

the selected asset has a available time.

### Item 5

The animation production system according to claim 1, wherein

the asset in the asset store is provided by a server connected via a network.

### Item 6

The animation production system according to claim 1, wherein

the asset in the asset store includes a character or object.

### Item 7

The animation production system according to claim 1, wherein

the asset in the asset store includes a character or an object with movement.

### Item 8

The animation production system according to claim 7, wherein

the movement of the character or object with the movement is a sample movement in which the movement is interrupted in the middle.

A specific example of an animation production system 300 according to an embodiment of the present invention will be described below with reference to the drawings. It should be noted that the present invention is not limited to these examples, and is intended to include all modifications within the meaning and scope of equivalence with the appended claims, as indicated by the appended claims. In the following description, the same elements are denoted by the same reference numerals in the description of the drawings and overlapping descriptions are omitted.

### Overview

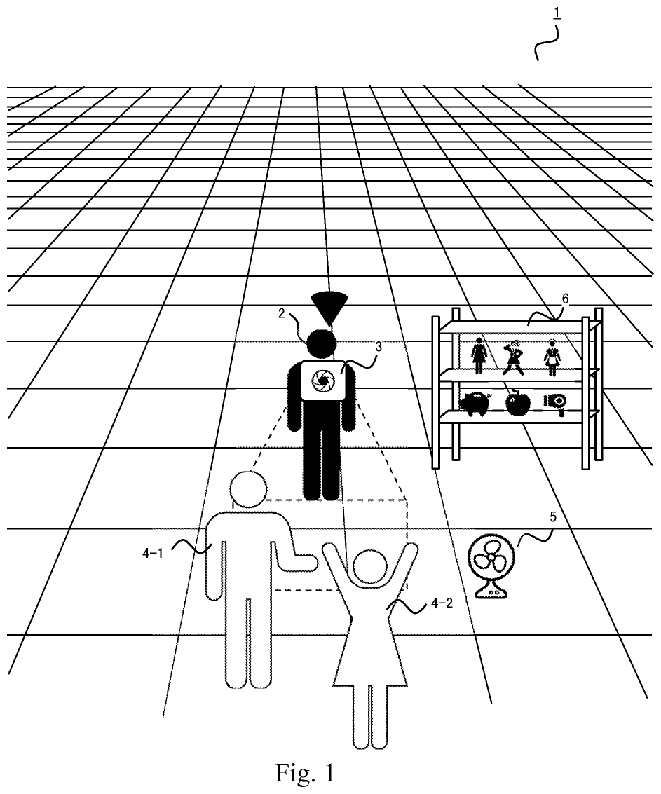

FIG. 1 is a diagram illustrating an example of a virtual space displayed on a head mount display (HMD) mounted by a user in an animation production system 300 according to the present embodiment. In the animation production system 300 of the present embodiment, a virtual character 4, a virtual object 5, and a virtual camera 3 are arranged in the virtual space 1, and a character 4 is shot using the camera 3. In the virtual space 1, a photographer 2 (a photographer character) is disposed, and the camera 3 is virtually operated by the photographer 2. In addition, the asset store 6 is installed in the virtual space 1, and depending on the possession described later, the user acquires the asset set of the asset store 6 as the camera man 2 or character 4 (e. g. , taking the asset by hand), and the asset can be used for photography.

In the animation production system 300 of the present embodiment, as shown in FIG. 1, a user makes an animation by arranging a character 4, an object 5, and a camera 3 while viewing the virtual space 1 from a bird's perspective using a TPV (Third Person's View), shooting a character 4 as a photographer 2 using FPV (First Person View; first person's perspective), or performing a character 4 using an FPV. In the virtual space 1, a plurality of characters 4 (in the example of FIG. 1, characters 4-1 and 4-2) can be disposed, and the user can perform the performance while possessing a character 4. If more than one character 4 is disposed, the user may also switch the object possessed by each character 4 (e. g. , characters 4-1 and 4-2). That is, in the animation production system 300 of the present embodiment, one can play a number of roles (roles). In addition, since the camera 3 can be virtually operated as the photographer 2, natural camera work can be realized and the representation of the movie to be shot can be enriched.

### General Configuration

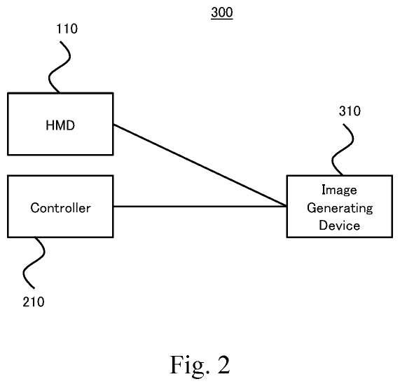

FIG. 2 is a diagram illustrating an example of the overall configuration of an animation production system 300 according to an embodiment of the present invention. The animation production system 300 may comprise, for example, an HMD 110, a controller 210, and an image generating device 310 that functions as a host computer. An infrared camera (not shown) or the like can also be added to the animation production system 300 for detecting the position, orientation and slope of the HMD 110 or controller 210. These devices may be connected to each other by wired or wireless means. For example, each device may be equipped with a USB port to establish communication by cable connection, or communication may be established by wired or wireless, such as HDMI, wired LAN, infrared, Bluetooth™, WiFi™. The image generating device 310 may be a PC, a game machine, a portable communication terminal, or any other device having a calculation processing function.

### HMD 110

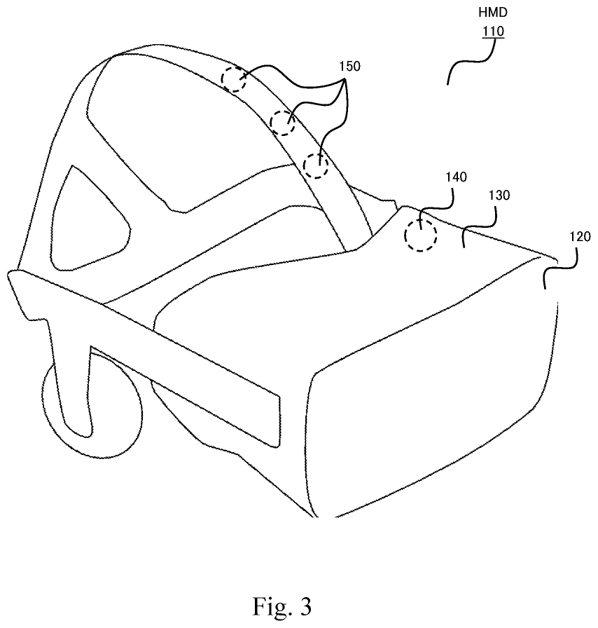

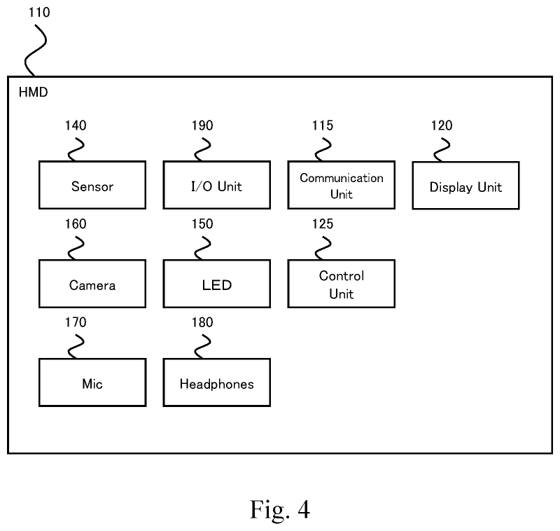

FIG. 3 shows a schematic view of the appearance of the HMD 110 according to the present embodiment. FIG. 4 is a diagram illustrating an example of a functional configuration of the HMD 110 according to the present embodiment.

The HMD 110 is mounted on the user's head and includes a display panel 120 for placement in front of the user's left and right eyes. Although an optically transmissive and non-transmissive display is contemplated as the display panel, this embodiment illustrates a non-transmissive display panel that can provide more immersion. The display panel 120 displays a left-eye image and a right-eye image, which can provide the user with a three-dimensional image by utilizing the visual difference of both eyes. If left- and right-eye images can be displayed, a left-eye display and a right-eye display can be provided separately, and an integrated display for left-eye and right-eye can be provided.

The housing portion 130 of the HMD 110 includes a sensor 140. Sensor 140 may comprise, for example, a magnetic sensor, an acceleration sensor, or a gyro sensor, or a combination thereof, to detect movements such as the orientation or tilt of the user's head. When the vertical direction of the user's head is Y-axis, the axis corresponding to the user's anteroposterior direction is Z-axis, which connects the center of the display panel 120 with the user, and the axis corresponding to the user's left and right direction is X-axis, the sensor 140 can detect the rotation angle around the X-axis (so-called pitch angle), rotation angle around the Y-axis (so-called yaw angle), and rotation angle around the Z-axis (so-called roll angle).

In place of or in addition to the sensor 140, the housing portion 130 of the HMD 110 may also include a plurality of light sources 150 (e. g. , infrared light LEDs, visible light LEDs). A camera (e. g. , an infrared light camera, a visible light camera) installed outside the HMD 110 (e. g. , indoor, etc.) can detect the position, orientation, and tilt of the HMD 110 in a particular space by detecting these light sources. Alternatively, for the same purpose, the HMD 110 may be provided with a camera for detecting a light source installed in the housing portion 130 of the HMD 110.

The housing portion 130 of the HMD 110 may also include an eye tracking sensor. The eye tracking sensor is used to detect the user's left and right eye gaze directions and gaze. There are various types of eye tracking sensors. For example, the position of reflected light on the cornea, which can be irradiated with infrared light that is weak in the left eye and right eye, is used as a reference point, the position of the pupil relative to the position of reflected light is used to detect the direction of the eye line, and the intersection point in the direction of the eye line in the left eye and right eye is used as a focus point.

### Controller 210

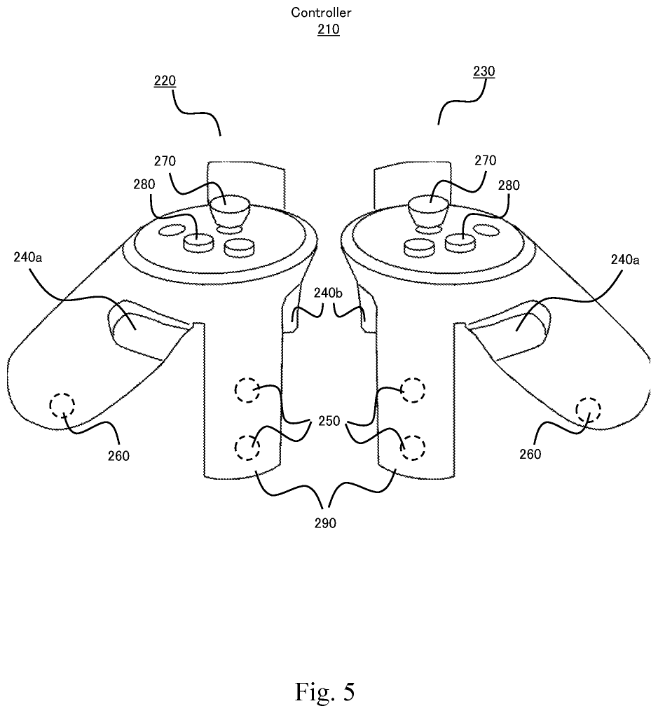

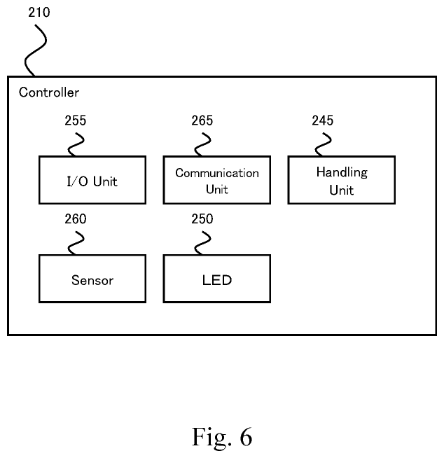

FIG. 5 shows a schematic view of the appearance of the controller 210 according to the present embodiment. FIG. 6 is a diagram illustrating an example of a functional configuration of a controller 210 according to this embodiment.

The controller 210 can support the user to make predetermined inputs in the virtual space. The controller 210 may be configured as a set of left-hand 220 and right-hand 230 controllers. The left hand controller 220 and the right hand controller 230 may each have an operational trigger button 240, an infrared LED 250, a sensor 260, a joystick 270, and a menu button 280.

The operation trigger button 240 is positioned as 240a, 240b in a position that is intended to perform an operation to pull the trigger with the middle finger and index finger when gripping the grip 235 of the controller 210. The frame 245 formed in a ring-like fashion downward from both sides of the controller 210 is provided with a plurality of infrared LEDs 250, and a camera (not shown) provided outside the controller can detect the position, orientation and slope of the controller 210 in a particular space by detecting the position of these infrared LEDs.

The controller 210 may also incorporate a sensor 260 to detect movements such as the orientation and tilt of the controller 210. As sensor 260, it may comprise, for example, a magnetic sensor, an acceleration sensor, or a gyro sensor, or a combination thereof. Additionally, the top surface of the controller 210 may include a joystick 270 and a menu button 280. It is envisioned that the joystick 270 may be moved in a 360 degree direction centered on the reference point and operated with a thumb when gripping the grip 235 of the controller 210. Menu buttons 280 are also assumed to be operated with the thumb. In addition, the controller 210 may include a vibrator (not shown) for providing vibration to the hand of the user operating the controller 210. The controller 210 includes an input/output unit and a communication unit for outputting information such as the position, orientation, and slope of the controller 210 via a button or a joystick, and for receiving information from the host computer.

With or without the user grasping the controller 210 and manipulating the various buttons and joysticks, and with information detected by the infrared LEDs and sensors, the system can determine the movement and attitude of the user's hand, pseudo-displaying and operating the user's hand in the virtual space.

### Image Generator 310

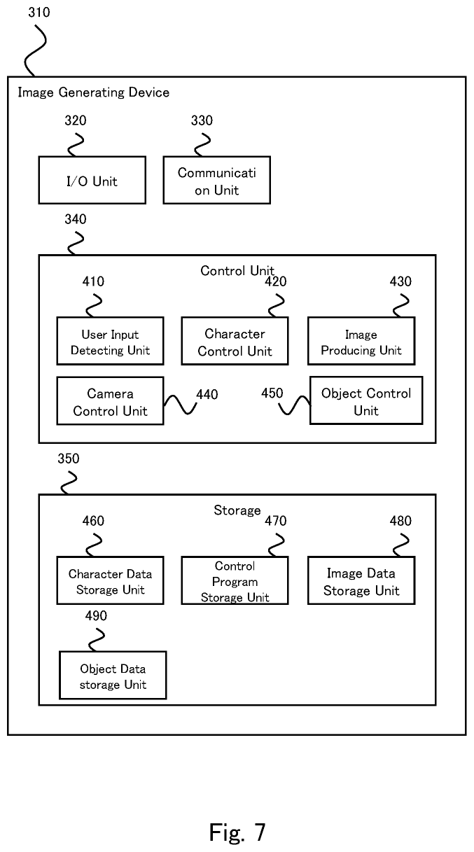

FIG. 7 is a diagram illustrating a functional configuration of an image producing device 310 according to the present embodiment. The image producing device 310 may use a device such as a PC, a game machine, a portable communication terminal, or the like, which has a function for storing information on the user's head movement or the movement or operation of the controller acquired by the user input information or the sensor, which is transmitted from the HMD 110 or the controller 210, performing a predetermined computational processing, and generating an image. The image producing device 310 may include an input/output unit 320 for establishing a wired connection with a peripheral device such as, for example, an HMD 110 or a controller 210, and a communication unit 330 for establishing a wireless connection such as infrared, Bluetooth, or WiFi (registered trademark). The information received from the HMD 110 and/or the controller 210 regarding the movement of the user's head or the movement or operation of the controller is detected in the control unit 340 as input content including the operation of the user's position, line of sight, attitude, speech, operation, etc. through the I/O unit 320 and/or the communication unit 330, and a control program stored in the storage unit 350 is executed in accordance with the user's input content to perform a process such as controlling the character 4 or the object 5 and generating an image. In addition, the object 5 can be controlled to operate in addition to the user's input contents. The control unit 340 may be composed of a CPU. However, by further providing a GPU specialized for image processing, information processing and image processing can be distributed and overall processing efficiency can be improved. The image generating device 310 may also communicate with other computing processing devices to allow other computing processing devices to share information processing and image processing.

The control unit 340 includes a user input detecting unit 410 that detects information received from the HMD 110 and/or the controller 210 regarding movement of the user's head or user speech, and information related to movement or operation of the controller, a character control unit 420 that executes a control program stored in the character data storage unit 460 of the storage unit 350, a camera control unit 440 that controls the virtual camera 3 disposed in the virtual space 1 according to the character control unit 470, an object control unit 450 that executes a control program stored in the control program storage unit 470 for an object 5 stored in the object data storage unit 490 of the storage unit 350, and an image producing unit 430 that generates an image in which the camera 3 captures the virtual space 1 based on the character control and/or object control. Here, the movement of the character 4 is controlled by converting information such as the direction, inclination, and hand movement of the user head detected through the HMD 110 or the controller 210 into the movement of each part of the bone structure created in accordance with the movement or restriction of the joints of the human body, and applying the bone structure movement to the previously stored character data. The control of the camera 3 is performed, for example, by changing various settings for the camera 3 (for example, the position within the virtual space 1 of the camera 3, the viewing direction of the camera 3, the focus position, the zoom, etc.) depending on the movement of the hand of the character 4.

The storage unit 350 stores in the aforementioned character data storage unit 460 information related to the character 4, such as the attribute of the character 4, as well as the image data of the character 4. Further, the control program storage unit 470 controls the operation and expression of the character 4 in the virtual space and stores a program for controlling the camera 3, the object 5, and the like. The image data storage unit 480 stores the image generated by the image producing unit 430. In addition to the image data of the object 5, information related to the object 5 (e. g. , operation contents, operation period, etc.) is stored in the object data storage unit 490.

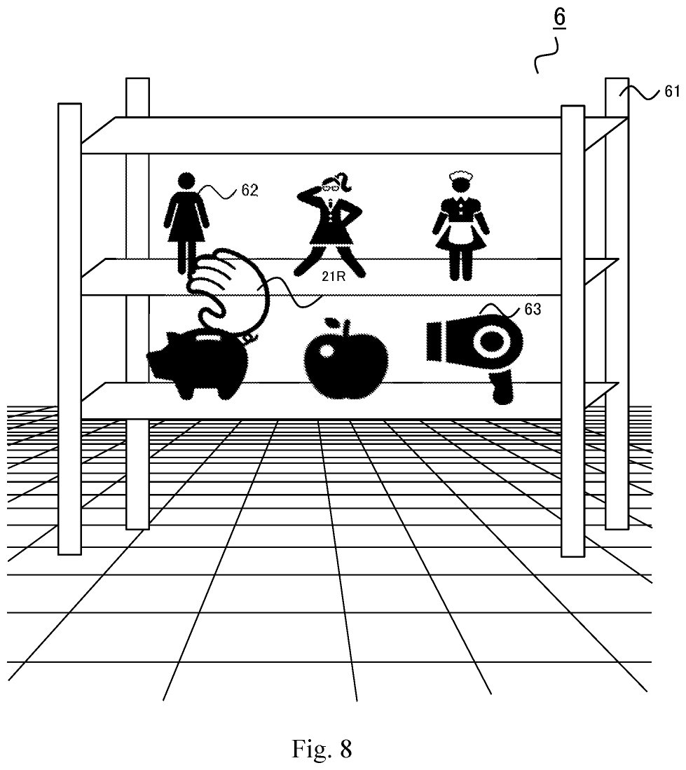

FIGS. 8-11 are diagrams illustrating a purchase of an asset from an asset store 6 in the animation production system 300 according to this embodiment. The asset store 6 of the present embodiment illustrates a configuration in which different types of assets are arranged in two stages in a shelf shape, but the configuration is not limited thereto, and the method of placement of the asset and the number of types of assets are optional. The object disposed as an asset may not be limited to an enlarged or reduced 3DCG model, but may also be a background that can be disposed in the virtual space 1, an icon (not shown) representing an intangible object such as an operation of the character 4 or a dialog of a character, or the like.

First, as shown in FIG. 8, a user approaches an asset store 6 disposed on a virtual space 1 by possessing, for example, a photographer 2 or a character 4. The asset store 6 may comprise, for example, a virtual shelf 61 in which a selling character 62 or a selling object 63 is disposed, and may be disposed in a predetermined position on the virtual space 1, or may be arranged to be called to a user's vicinity or the like in response to predetermined operations (including audio operations). The user then selects the goods by grasping the sales character 62 or the sales object 63, for example, by using the virtual right hand 21R in the virtual space 1. The assets disposed in the asset store 6 may be, for example, periodically updated, arranged on the basis of conditions set by the asset condition window (not shown), or may be based on a sales history or the like to learn the user's preferences and display the assets in accordance with the user's preferences. Assets disposed in the asset store 6 may also be sold as a set of identical or different types of assets together, rather than as a single asset. Additionally, the asset located in the asset store 6 may be data acquired from a server connected via a network, e. g. , a cloud server.

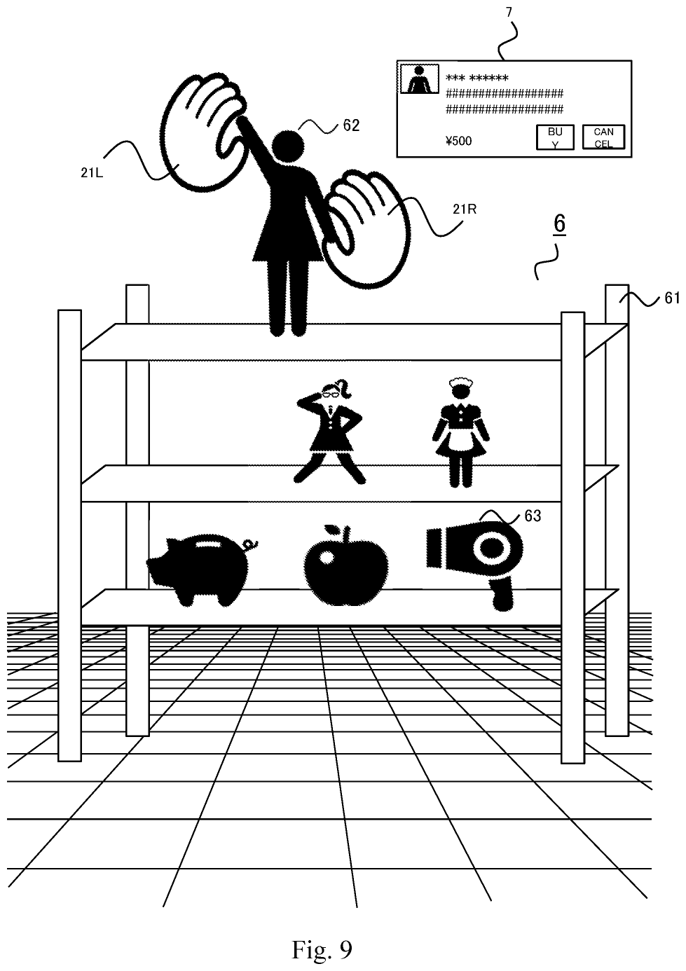

Next, as shown in FIG. 9, the user can freely operate the grabbed sales character 62, such as a doll or figure, by the virtual right hand 21R and/or the virtual left hand 21L in the virtual space 1. This makes it possible for a user to make a desired pause, for example, and makes it easier to consider how to use it in the virtual space 1 after purchase. At this time, for example, the information window 7 (e. g. , a detailed description of the product, a detailed setting, an amount at the time of purchase, etc.) may be displayed, and the information may be displayed when the sales character 62 is grasped or when the user watches the sales character 62. Further, after the sales character 62 is disposed in the virtual space 1 as a character 4, a body part such as an arm, a leg, or a trunk of the disposed character 4 can be operated.

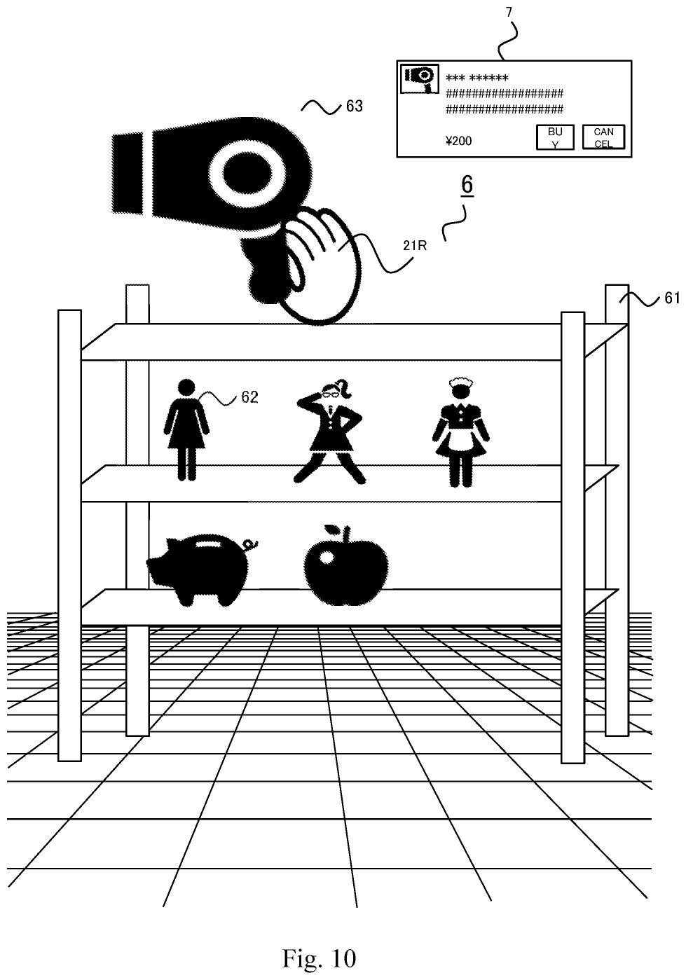

Also, as shown in FIG. 10, the selling object 63 may be grasped from the asset store 6 and virtually utilized (e. g. , operated) in the virtual space 1. As a result, since the user can confirm the operation of the sales object 63, it is possible to actually use the image in the virtual space 1 and consider how to use the image after the purchase, thereby increasing the convenience. Also, if the selling object 63 includes a movable part, the movable part may be grasped and operated to alter the attitude of the selling object 63. Further, after the selling object 63 is disposed as the object 5 in the virtual space 1, the movable part of the object 5 may be moved using the virtual right hand 21R or the virtual left hand 21L to change the attitude of the object 5. For example, in accordance with the operation of the character 4, the shape, attitude, movement, etc. of the object 5 to which the character 4 is mounted can be adjusted. For example, in the case where the character 4 is mounted on a skirt and the skirt is enlarged, the skirt may be moved in conjunction with the flexing and extending motion of the character 4 and the movement of the arms and hands, for example, by grasping and moving a bon loaded into the skirt.

Also, for example, the selling object 63 may be removed from the asset store 6 and placed in the virtual space 1 so that its status can be checked. For example, the costume selling object 63 can be removed from the asset store 6 and tried to mount on the character 4 to see how it will look. In addition, it is not only possible to temporarily wear the watch on a trial basis, but it may also be rentable so that it can be used for a limited period of time even in actual photography. In this case, for each sold sales object 63, it is possible to manage the user of the customer and the period of time available.

Also, if the selling object 63 is an object that can be mounted to the character 4, the selling object 63 may be mounted to the character 4 by dragging and dropping in the virtual space 1. For example, by grasping the selling object 63 from the asset store 6 and superimposing it on the character 4, the character control unit 420 may update the character 4 in a state in which the costume pertaining to the selling object 63 is mounted by the character 4.

Also, when the selling object 63 is a wig, the character control unit 420 can change the hair type of the character 4 when the selling object 63 is grabbed by the virtual right hand 21R or the virtual left hand 21L and dropped onto the character 4. In addition, when the selling object 63 is a hair extension (hereinafter, abbreviated as an extension), the character control unit 420 may paste one end of the extension at a place of the character 4 closest to the position where the extension is dropped. In addition, the movement of the hair is set in the ext, and the posture and shape of the ext can be changed depending on the movement of the character 4 or regardless of the operation of the character 4.

In addition, when the selling object 63 is an ophthalmic object, it may be mounted to the character 4 and the shape of the object 5 after mounting may be fine-tuned. For example, the size of the object 5 may be changed to adjust the shape of the frame so as to fit the head of the character 4.

Also, if the selling object 63 is an accessory, the accessory can be attached to the dropped character 4. When the selling object 63 of the accessory is grasped by the virtual right hand 21R or the virtual left hand 21L and dropped onto the character 4, the character control unit 420 may allow the accessory to be mounted at a predetermined position in the character 4. If the mounting position is variable, the accessory may be pasted at a position on the object of the character 4 closest to the dropped position. If the accessories can be combined, the two accessories can be combined to create a new accessory when other accessories are dropped on the accessory.

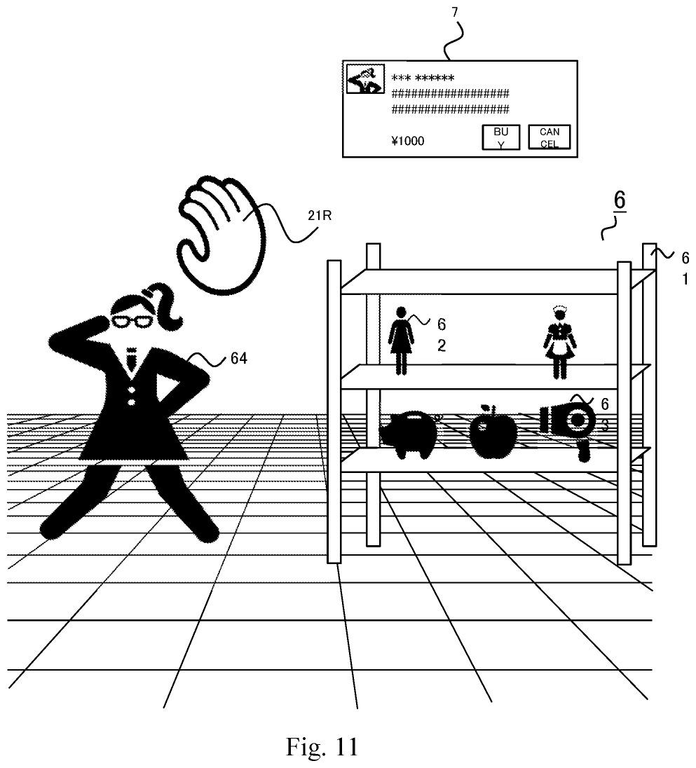

Also, as shown in FIG. 11, an operating selling character 62 (e. g. , dancing, reacting, etc.) can be grasped from the asset store 6 and placed in the virtual space 1 to confirm its operation. At this time, as shown in FIG. 11, for example, the size of the virtual space 1 may be increased. Accordingly, since the user can confirm the operation, etc. applied to the sales character 62, it is possible to actually check and examine how to use the image after the purchase in the virtual space 1, thereby increasing the convenience. In addition, from a promotional standpoint, a sample action (e. g. , only a dance output) may be displayed which interrupts the action applied to the sales character 62 and/or the sales object 63 and the like.

Following FIGS. 9-11, for example, after checking the contents of information window 7, the purchase procedure may be performed by pressing the purchase decision button (BUY) on information window 7 or the button to which the decision action of controller 210 has been assigned.

As described above, the purchase of assets has been described in accordance with FIGS. 8-11, but rental may also be substantially similar, except that the use period after payment is limited. Also, a method substantially similar to the method described in FIGS. 8-11 can be used to visualize assets already held in virtual space 1.

According to the animation production system 300 of the present embodiment, the asset can be purchased in the virtual space 1, so that the asset can be readily prepared. In particular, because it can be grasped by a virtual hand and used in a virtual space, it is possible to consider purchasing while imagining how to use it for shooting after purchase, thereby reducing unnecessary shopping and corrections. In addition, the range of animated video representations is wider because the producer can purchase assets that could not be created by itself. Thus, it reduces the burden of animation production and provides a richer representation of animated video.

Although the present embodiment has been described above, the above-described embodiment is intended to facilitate the understanding of the present invention and is not intended to be a limiting interpretation of the present invention. The present invention may be modified and improved without departing from the spirit thereof, and the present invention also includes its equivalent.

For example, in the present embodiment, the image generating device 310 may be a single computer, but not limited to the HMD 110 or the controller 210 may be provided with all or some of the functions of the image generating device 310. It may also include a function of a portion of the image generating device 310 to other computers that are communicatively connected with the image generating device 310.

In the present exemplary embodiment, a virtual space based on the virtual reality (VR; Virtual Reality) was assumed. However, the animation production system 300 of the present exemplary embodiment is not limited to an extended reality (AR; Augmented Reality) space or a complex reality (MR; Mixed Reality) space, but the animation production system 300 of the present exemplary embodiment is still applicable.

### EXPLANATION OF SYMBOLS

1 virtual space

2 cameraman

3 cameras

4 characters

5 objects

6 Asset Store

110 HMD

120 display panel

130 housing

140 sensor

150 light source

210 controller

220 left hand controller

230 right hand controller

235 grip

240 trigger button

250 Infrared LED

260 sensor

270 joystick

280 menu button

300 Animation Production System

310 Image Generator

320 I/O portion

330 communication section

340 controller

350 storage

410 User Input Detector

420 character control unit

430 Image Generator

440 Camera Control

450 object control

460 Character Data Storage Block

470 Program Storage

480 Image Data Storage

490 Object Data Storage

1. An animation production system comprising:
a virtual camera that shoots a character placed in a virtual space;
an asset store provided in the virtual space in which an asset available for the shooting is disposed in the virtual space; and
a virtual hand of a user in the virtual space,
wherein the asset selected from the asset store can be operated by the virtual hand.

2. The animation production system according to claim 1, wherein
the selected asset will be used at cost.

3. The animation production system according to claim 2, wherein
the selected asset can be operated prior to payment of the cost.

4. The animation production system according to claim 1, wherein
the selected asset has a available time.

5. The animation production system according to claim 1, wherein
the asset in the asset store is provided by a server connected via a network.

6. The animation production system according to claim 1, wherein
the asset in the asset store includes a character or object.

7. The animation production system according to claim 1, wherein
the asset in the asset store includes a character or an object with movement.

8. The animation production system according to claim 7, wherein
the movement of the character or object with the movement is a sample movement in which the movement is interrupted in the middle.
